(19) United States
(12) Patent Application Publication
(10) Pub. No.: US 2010/0213157 A1
(43) Pub. Date: Aug. 26, 2010

(54) FEEDING BOTTLE FOR BABIES

(76) Inventor: John Michael Hamilton-Hall, Centurion (ZA)

Correspondence Address: TODD S. PARKHURST;HUGHES SOCOL PIERS RESNICK & DYM LTD., THREE FIRST NATIONAL PLAZA, 70 WEST MADISON; SUITE 4000, CHICAGO, IL, 60602, US

(21) Appl. No.: 12/601,223

(22) PCT Filed: Mar. 19, 2008
(86) PCT No.: PCT/ZA2008/000022

§ 371 Date: Feb. 2, 2010

(30) Foreign Application Priority Data
May 27, 2007 (ZA) 2007/4334

(51) Int. Cl. A61J 9/08

(52) U.S. Cl. 215/11.6

(57) ABSTRACT

The invention relates to a baby feeding bottle and an assembly therefor. The baby feeding bottle includes a container and a teat unit. The teat unit includes a teat, a teat support and means for piercing a membrane arranged on the mouth of the container. The bottle further includes a teat unit and container separation resistance arrangement. The teat unit is configured so that the means for piercing the membrane pierce the membrane when the teat unit, or part thereof, is moved, in use, towards the membrane so that the baby feed is accessible through the teat.

### TECHNICAL FIELD OF THE INVENTION

This invention relates to a feeding bottle for babies. More particularly, it relates to a non reusable disposable feeding bottle.

### BACKGROUND TO THE INVENTION

The applicant is aware of the high mortality rate of babies in developing countries. The applicant believes that the use of non sterile feeding bottles may contribute to the high mortality rate of babies by transmission of cholera, dysentery and other diseases. If the mother is infected with the HIV virus breastfeeding is discouraged and often the mother does not have the means to sterilise the feeding bottle or drinking water prior to feeding her baby.

The applicant is aware of disposable baby feeding bottles such as those described in U.S. Pat. No. 4,801,007, which describes a tubular teat mounting with its lower end configured to pierce a container wall forming a seal against the wall of the container. This bottle components need to be handled to prepare for feeding, which exposes them to contamination and the mounting can be reused. U.S. Pat. No. 7,098,431 describes a feeding bottle cap arrangement which includes two threaded lids with a closable compartment for powdered milk, which compartment is opened to a container by turning one of the lids and pierced by turning the other lid. However, the whole feeding arrangement can be screwed on the container and refilled with feeding liquid and reused. U.S. Pat. No. 6,138,847 describes a bottle that should not be reused since the flange of the teat is sealingly latched onto a collar of the container. It is conceivable that the latch mechanism can be opened and the bottle reused. Also, the teat of this bottle is inverted into the container and in contact with the premixed feeding mixture which is undesirable since the feeding hole can get clogged and the teat may be difficult to reposition outside of the container, especially if It was subjected to heat or when fluid flowed through the hole prior to feeding. Any fluid that flowed through the hole in the teat prior to use will be spilled when the teat is inverted into its outside position. These arrangements are complicated and expensive to manufacture. The applicant also believes that it is critical for the arrangement to be non reusable to prevent persons from reusing the bottles and spreading disease. It is not sufficient to rely on a person to decide not to reuse the bottle, it must be impossible without special tools to reuse the bottle.

It is an object of this invention to provide a low cost failsafe sterile baby feeding bottle that cannot be reused.

### GENERAL DESCRIPTION OF THE INVENTION

According to one aspect of the invention there is provided a baby feeding bottle, the bottle including:
a container;
a teat unit, the teat unit including, a teat, a teat support and means for piercing a membrane;
a sealing membrane secured on the mouth of the container;
wherein the teat unit is configured so that the means for piercing the membrane pierce the membrane when the teat unit, or part thereof, is moved, in use, towards the membrane so that the baby feed is accessible through the teat; and
and a teat unit and container separation resistance arrangement.

The separation resistance arrangement may include a non removable coupling between the teat unit and the container.

The coupling may be formed by an adhesive seal.

The coupling may be formed by a thread defined on the inside of the teat unit for threaded coupling with a thread defined on a neck of the container, and wherein the container separation resistance arrangement includes a one directional ratchet assembly for one directional turning of the teat unit to help prevent unscrewing of the teat unit. Additionally, the separation resistance arrangement may include a friction reduction ring between the container, directly or indirectly, and the teat unit to further prevent unscrewing of the teat unit.

The teat unit may include a stopper for stopping the piercing means short of the membrane to prevent accidental piercing.

The container separation resistance arrangement may include an irreversible interlocking arrangement when the teat unit, or part thereof, is moved towards the membrane and the membrane is pierced, in use.

The baby feeding bottle according to any one of the preceding claims, wherein the separation resistant arrangement is configured so that, whenever there is an attempt to separate the teat unit from the container, the separation resistant arrangement irreversibly breaks or separates the teat unit, or part thereof, from the container in such a way that it cannot be coupled together again in a usable way.

The means for piercing the membrane includes a blade on the teat unit, or part thereof, which part is moved, in use, towards the membrane with the free end of the blade pointing towards the membrane.

The teat unit may be configured so that turning a portion of a teat unit on a thread, moves the means for piercing the membrane towards the membrane.

The teat unit may be configured so that pushing a portion of a teat unit towards the membrane, moves the means for piercing the membrane towards the membrane.

The baby feeding bottle may include a cap that encloses the teat unit.

The cap may include a stopper for preventing the teat unit or part thereof from being moved to pierce the membrane, or prevents access to a person to the teat unit, or part thereof, to prevent a person from piercing the membrane.

The cap may be provided with a tamper evident cap release mechanism. The release mechanism may include a removable strip, which strip includes a catch for catching the teat unit or container and may include a stopper to prevent the teat unit or part thereof to be accidentally moved towards the membrane so that the piercing means pierce the membrane.

The teat support may in the form of a teat support ring and the baby feeding bottle arrangement further includes a tubular collar having two axially aligned catch formations both axially aligned with the teat support ring and complementary to the catch formation of the teat support ring, for catching of the teat support ring in a snap lock manner in a two stage catch position of the teat support ring relative to the tubular collar.

The invention also relates to an assembly for a baby feeding bottle, the assembly including:
a teat unit, the teat unit including, a teat, a teat support and means for piercing a sealing membrane provided over the opening of a container;
an arrangement configured to resist the separation of the teat unit and a container, when the teat unit coupled to a container; and
wherein when the teat unit is configured so that the means for piercing the membrane pierce the membrane when the teat unit, or part thereof, is moved, in use, towards the membrane so that the baby feed is accessible through the teat.

According to another aspect of the invention there is provided a teat unit for baby feeding bottle arrangement, which teat unit includes:

a teat support ring having a catch formation about its circumference and a tube extending operatively downward from the inner diameter of the ring;

a tubular collar having a catch formation axially aligned, in use, with the teat support ring and complementary to the catch formation of the teat support ring, for catching of a teat support ring in a snap lock manner; and

a separation resistant arrangement in the form of a weakened area proximate any of the complementary formations which is configured to break should anyone attempt to forcibly unlock the snap lock formations such that the complementary formations cannot thereafter be locked together again.

The teat support may be in the form of a support ring preferably in the form of tubular collar of the baby feeding bottle arrangement having two axially aligned catch formations to enable a two stage catch of the teat support ring relative to the tubular collar.

The operatively lower end of the tube may be configured to pierce a membrane.

The complementary catch formations may be positioned such that the lower end of the tube is operatively above the membrane in the first stage catch position and has pierced the membrane in the second stage catch position.

The catch for the first stage catch position may be any formation which keeps the teat support ring in position.

The teat support ring may be slidable inside the tubular collar having, on the inside, a first stage upper catch formation and a lower second stage catch formation.

A teat may extend from the teat support ring opposite the tube.

The tubular collar may be provided with an inward extending shoulder proximate its lower edge against which the lower surface of the teat support ring sealingly contacts when the teat support ring is caught in the second stage catch formation. A flange of the resiliently deformable teat may provide the seal between the shoulder and the lower surface of the teat support ring.

A membrane may extend across the lower end of the opening of the tubular collar, preferably across the shoulder of the tubular collar.

The baby feeding bottle arrangement may include a cap for covering the teat of the arrangement in an airtight manner.

The tubular collar may be attached or fitted to a container.

It will be understood that the baby feeding bottle arrangement needs to be sealingly fitted to the container before the bottle is distributed under sterile conditions, usually on the assembly line.

The container may preferably be of a collapsible plastics or paper based material.

The container may, in one embodiment, be comprised of two compartments, one for a dry substance and one for a liquid, the compartments being arranged so that both will be pierced by the lower end of the tube when the teat support ring is caught in the second stage catch formation.

### DETAILED DESCRIPTION OF THE INVENTION

The invention is now described by way of example with reference to the accompanying drawings.

In the drawings:

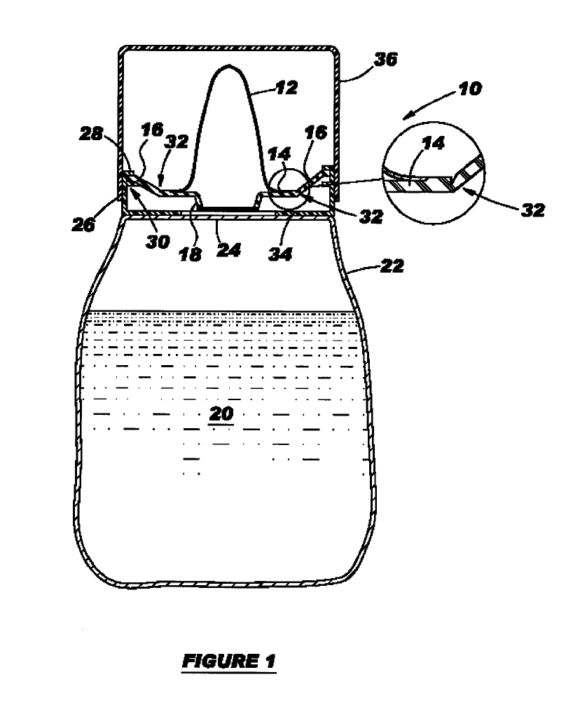

FIG. 1 shows one embodiment of a baby feeding bottle in a first stage catch state, in accordance with the invention;

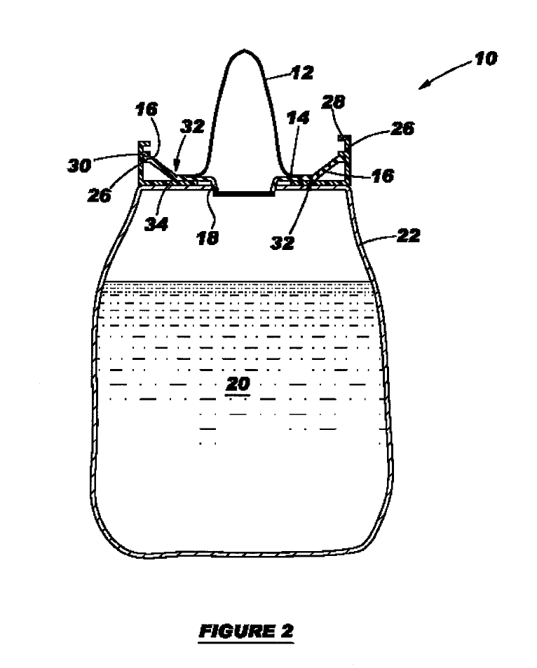

FIG. 2 shows the baby feeding bottle in a second stage catch state;

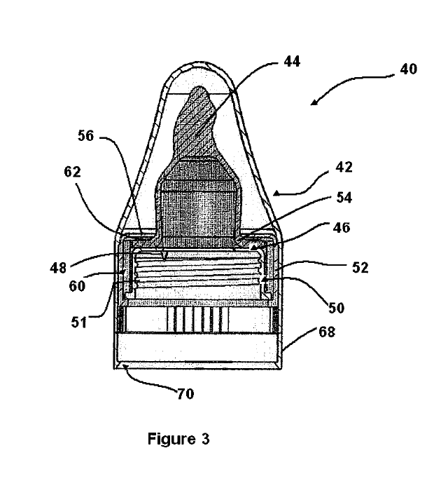

FIG. 3 shows a sectional side view of an assembly for a baby feeding bottle for a further embodiment of the invention, in accordance with the invention;

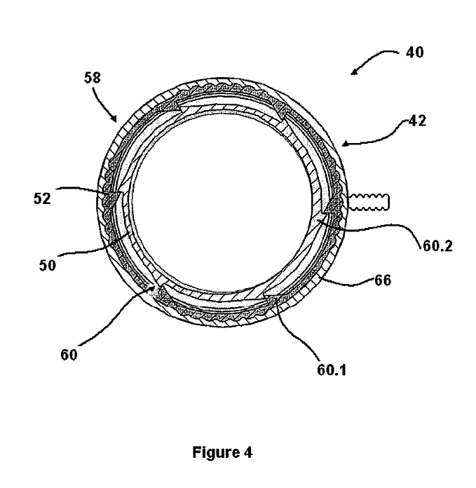

FIG. 4 shows a sectional plan view of the assembly;

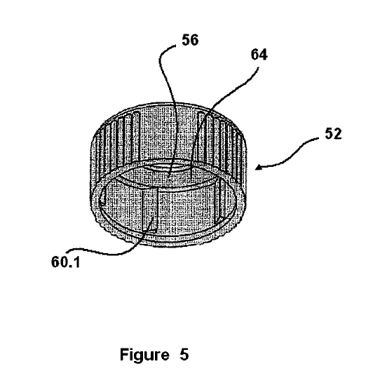

FIG. 5 shows a perspective view of an outer lid of the assembly;

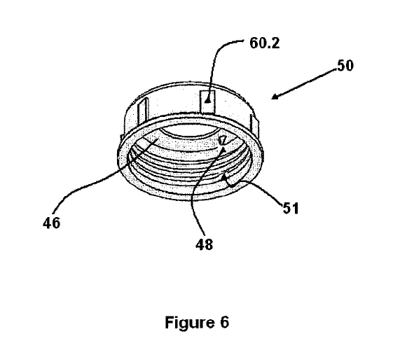

FIG. 6 shows a perspective view of an inner lid of the assembly; and

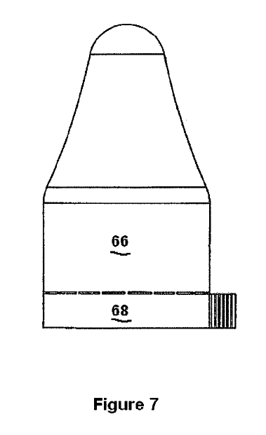

FIG. 7 shows a side view of a cap of the assembly.

Referring now to the drawings, FIGS. 1 and 2, the baby feeding bottle, in accordance with the invention, is generally indicated by reference numeral 10.

A baby feeding bottle 10 includes a teat 12 attached to a teat support ring 14 having a catch formation 16 about its circumference. The teat support ring 14 is attached to collapsible container 22 filled with a baby feeding liquid formula 20. The teat support ring 14 is separated from the contents of the container 22 by a membrane 24. The teat support ring 14 further includes a tube 18 extending operatively downward from the inner diameter of the ring with a serrated free end for piercing the membrane 24. The baby feeding bottle arrangement 10 further includes a tubular collar 26 having two axially aligned catch formations 28 and 30, both axially aligned with the teat support ring 14 and complementary to the catch formation of the teat support ring 16, for catching of the teat support ring in a snap lock manner in a two stage catch position of the teat support ring relative to the tubular collar.

The teat support ring 14 is further provided with a weakened area 32 proximate the catch formation 16, which is configured to break should anyone attempt to forcibly unlock the snap lock formations such that the complementary formations cannot thereafter be locked together again.

The teat support ring 14 is slidable inside the tubular collar 26 having, on the inside, a first stage upper catch formation 28 and a lower second stage catch formation 30. The complementary catch formations 16, 28 and 30 are positioned such that the lower end of the tube 18 is operatively above the membrane 24 in the first stage catch position (FIG. 1) and has pierced the membrane in the second stage catch position (FIG. 2).

The tubular collar 26 is provided with an inward extending shoulder 34 extending from its lower edge against which the lower surface of the teat support ring 14 sealingly contacts when the teat support ring is caught in the second stage catch formation.

The baby feeding bottle arrangement includes a cap 36 for covering the teat 12 of the arrangement in an airtight manner and sterile manner.

In one embodiment of the invention, on the assembly line, the collapsible plastics container 22 of a pre assembled baby feeding bottle arrangement 10 will be filled through an opening in the container with a liquid ultra pasteurised baby feeding formula 20 and the container will be sealed. It will be appreciated that the wall of the container 22 defines the membrane 24. In use, a mother or caretaker will remove the cap 36, push the support ring 16 down to pierce the membrane and the bottle is ready for feeding. The feeding bottle arrangement 10 is not reusable and will be discarded.

Referring now to the drawings, FIGS. 3 to 7, the baby feeding bottle assembly, in accordance with the invention, is generally indicated by reference numeral 40.

The baby feeding bottle assembly to be threadedly attached to a membrane sealed baby feed containing container, or bottle (not shown), includes a teat unit 42. The teat unit 42 includes a teat 44, a teat support collar 46 and a piercing means 48 for piercing a membrane in the form of a pointed protrusion extending downward from the inner side of the teat support collar. The teat unit also includes an inner lid 50, which includes a thread 51 on its inside for threaded attaching to a complementary threaded neck of a container (not shown), and an outer lid 52, which fits over the inner lid capturing the flange 54 of the teat 44 between an upper lid collar 56 and the teat support collar 46 defined by the inner lid 50. The teat unit 42 is configured so that the piercing means 48 pierce the membrane when the teat unit 42 threadedly moves downward onto a threaded neck of a container until the inner lid 50 seals with the opening of the container so that the baby feed is accessible through the teat.

The baby feeding bottle assembly 40 also includes a teat unit and container separation resistance arrangement 58. The teat unit and container separation resistance arrangement 58 includes a non removable coupling between the teat unit 42 and the container (not shown). The coupling is formed by the thread 51 defined on the inside of the inner lid 50 of the teat unit 42 for threadedly coupling with a thread defined on a neck of the container. The container separation resistance arrangement 58 also includes a one directional ratchet assembly 60 for one directional turning of the teat unit to help prevent unscrewing of the teat unit 42 for re-use. The one directional ratchet assembly 60 includes complementary catches 60.1 and 60.2, respectively arranged radially about the inside of the outer lid 52 and the outside of the inner lid 50. Additionally, the separation resistance arrangement 58 includes a friction reduction ring 62 sandwiched between the respective collars 46 and 64, respectively, of the inner 50 and outer 52 lids.

The baby feeding bottle assembly 40 further includes a cap 66 that encloses the teat unit 42. The cap 66 includes a stopper 68 for preventing inner lid 50 of the teat unit 42 from being moved to pierce the membrane. The stopper 68 also functions a tamper evident cap release mechanism in the form of a removable strip, which strip includes a catch 70 for catching a complementary catch on the neck of the container (not shown).

During manufacture, a container with a complementary neck to the teat unit will be filled with a selected formula for feeding a baby. The neck of the container will then be sealed with a pierceable membrane and the teat assembly 40 will then be screwed onto the neck of the container until the bottom edge of the stopper 68 catches the neck and fits snugly. The container and contents will then be sterilised such as with gamma radiation and it is then ready for use. In use, a person will remove the stopper 68 and thereby break the tamper evident seal and screw the teat unit 42 onto the neck of the container all the way the pierce the membrane and seal the teat unit against the rim of the neck of the container. Then the baby can be fed. The teat unit 42 and container separation resistance arrangement 58 prevents the teat unit from being removed in a useable state.

It shall be understood that the examples are provided for illustrating the invention further and to assist a person skilled in the art with understanding the invention and are not meant to be construed as unduly limiting the reasonable scope of the invention.

1. A baby feeding bottle, the bottle including;
a container;
a teat unit, the teat unit including, a teat, a teat support and means for piercing a membrane;
a sealing membrane secured on the mouth of the container;
a teat unit and container separation resistance arrangement; and
wherein when the teat unit is configured so that the means for piercing the membrane pierce the membrane when the teat unit, or part thereof, is moved, in use, towards the membrane so that the baby feed is accessible through the teat.

2. The baby feeding bottle according to claim 1, wherein the separation resistance arrangement includes a non removable coupling between the teat unit and the container.

3. The baby feeding bottle according to claim 2, wherein the coupling is formed by an adhesive seal.

4. The baby feeding bottle according to claim 2, wherein the coupling is formed by a thread defined on the inside of the teat unit for threadedly coupling with a thread defined on a neck of the container and wherein the container separation resistance arrangement includes a one directional ratchet assembly.

5. The baby feeding bottle according to claim 4, wherein the teat unit includes a stopper for stopping the piercing means short of the membrane.

6. The baby feeding bottle according to any one of claims 1 to 4, wherein the container separation resistance arrangement includes an irreversible interlocking arrangement when the teat unit, or part thereof, is moved towards the membrane and the membrane is pierced, in use.

7. The baby feeding bottle according to any one of the preceding claims, wherein the separation resistant arrangement is configure that, whenever there is an attempt to separate the teat unit from the container, the separation resistant arrangement irreversibly breaks.

8. The baby feeding bottle according to any one of the previous claims, wherein the means for piercing the membrane includes a blade on the teat unit, or part thereof, which part is moved, in use, towards the membrane with the free end of the blade pointing towards the membrane.

9. The baby feeding bottle according to any of the preceding claims, wherein the teat unit is configured so that turning a portion of a teat unit on a thread, moves the means for piercing the membrane towards the membrane.

10. The baby feeding bottle according to any of the preceding claims 1 to 8, wherein the teat unit is configured so that pushing a portion of a teat unit towards the membrane, moves the means for piercing the membrane towards the membrane.

11. The baby feeding bottle according to any of the preceding claims, wherein the baby feeding bottle includes a cap that encloses the teat unit.

12. The baby feeding bottle as claimed in claim 11, wherein the cap includes a stopper for preventing the teat unit or part thereof from being moved to pierce the membrane, or prevents access to a person to the teat unit, or part thereof, to prevent a person from piercing the membrane.

13. The baby feeding bottle as claimed in claim 12, wherein the cap is provided with a tamper evident cap release mechanism.

14. The baby feeding bottle as claimed in claim 13, wherein the release mechanism includes a removable strip, which strip includes a catch for catching the teat unit or container and a stopper.

15. The baby feeding bottle according to any of the preceding claims, wherein the teat support is in the form of a teat support ring and the baby feeding bottle arrangement further includes a tubular collar having two axially aligned catch formations both axially aligned with the teat support ring and complementary to the catch formation of the teat support ring, for catching of the teat support ring in a snap lock manner in a two stage catch position of the teat support ring relative to the tubular collar.

16. A cap assembly for a baby feeding bottle, the assembly including:
a teat unit, the teat unit including, a teat, a teat support and means for piercing a sealing membrane provided over the opening of a container;
an arrangement configured to resist the separation of the teat unit and a container, when the teat unit coupled to a container; and
wherein when the teat unit is configured so that the means for piercing the membrane pierce the membrane when the teat unit, or part thereof, is moved, in use, towards the membrane so that the baby feed is accessible through the teat.

17. A teat unit for baby feeding bottle arrangement, which teat unit includes:
a teat support ring having a catch formation about its circumference and a tube extending operatively downward from the inner diameter of the ring;
a tubular collar having a catch formation axially aligned, in use, with the teat support ring and complementary to the catch formation of the teat support ring, for catching of a teat support ring in a snap lock manner; and
a separation resistant arrangement in the form of a weakened area proximate any of the complementary formations which is configured to break should anyone attempt to forcibly unlock the snap lock formations such that the complementary formations cannot thereafter be locked together again.

18. A baby feeding bottle, substantially as described herein with reference to the accompanying drawings.

19. A cap assembly for a baby feeding bottle, substantially as described herein with reference to the accompanying drawings.

20. A teat unit for baby feeding bottle arrangement, substantially as described herein with reference to the accompanying drawings.
